(19) United States
(12) Patent Application Publication
(10) Pub. No.: US 2025/0034441 A1
(43) Pub. Date: Jan. 30, 2025

(54) ADHESIVE

(71) Applicant: Murata Manufacturing Co., Ltd., Kyoto-fu (JP)

(72) Inventors: Naoki OGAWA, Nagaokakyo-shi (JP); Yoshitaka MURAKAMI, Nagaokakyo-shi (JP)

(73) Assignee: Murata Manufacturing Co., Ltd., Kyoto-fu (JP)

(21) Appl. No.: 18/783,097

(22) Filed: Jul. 24, 2024

(30) Foreign Application Priority Data
Jul. 28, 2023 (JP) 2023-123050

(51) Int. Cl. C09J 163/00; C08G 59/24; C08K 3/013; C08K 5/54; C09J 11/04; C09J 11/06; H01F 27/26

(52) U.S. Cl. CPC C09J 163/00; C08G 59/245; C08K 3/013; C08K 5/54; C09J 11/04; C09J 11/06; C08K 2201/005; C08K 2201/01; H01F 27/266

(57) ABSTRACT

An adhesive includes a bisphenol F resin, a curing agent for the bisphenol F resin, and magnetic powder. The volume ratio of the magnetic powder to the adhesive is 35 vol % or lower. The number average molecular weight of the bisphenol F resin is 312 to 360 g/mol.

### CROSS-REFERENCE TO RELATED APPLICATION

This application claims benefit of priority to Japanese Patent Application No. 2023-123050, filed Jul. 28, 2023, the entire content of which is incorporated herein by reference.

### BACKGROUND

### Technical Field

The present disclosure relates to an adhesive.

### Background Art

A coil component disclosed in Japanese Unexamined Patent Application Publication No. 2021-190633 includes a core. The core includes a winding core and two flanges. The winding core has a quadrilateral prism shape. One of the two flanges is connected to one side of the winding core, and the other flange is connected to the other side of the winding core. Each flange protrudes from the winding core outward in a direction perpendicular to the central axis line of the winding core. The core is made of a magnetic material. The coil component also includes a top plate. The top plate has a substantially rectangular planar shape. The top plate is connected to the core so as to link the two flanges therebetween like a bridge. The coil component includes an adhesive. The adhesive is interposed between the top plate and the core and bonds the top plate and the core with each other. The adhesive contains magnetic powder.

### SUMMARY

The adhesive used in the coil component disclosed in the above-described publication contains magnetic powder, so that the permeability becomes higher than an adhesive without magnetic powder. Nevertheless, as the proportion of magnetic powder contained in an adhesive is larger, the viscosity of the adhesive tends to become higher. If the viscosity of the adhesive is excessively high, at the time of the application of the adhesive to a top plate using a jig, for example, the adhesive may become stringy between the jig and the top plate. That is, the increased viscosity of an adhesive makes it difficult to handle the adhesive at the time of its application. It is thus desirable to provide an adhesive which can secure a sufficiently high permeability and which is also simple and easy to handle at the time of the manufacturing of a component to which the adhesive is applied.

To address the above-described issue, an aspect of the present disclosure provides an adhesive including a bisphenol F resin, a curing agent for the bisphenol F resin, and magnetic powder. The volume ratio of the magnetic powder to the adhesive is 35 vol % or lower. The number average molecular weight of the bisphenol F resin is 312 to 360 g/mol.

With the above-described configuration, the adhesive can secure a sufficiently high permeability and is also simple and easy to handle at the time of the manufacturing of a component to which the adhesive is applied.

### BRIEF DESCRIPTION OF THE DRAWINGS

FIG. 1 is a perspective view of a coil component;

FIG. 2 is an exploded perspective view of the coil component;

FIG. 3 is a schematic view of an adhesive in an uncured state;

FIG. 4 is a graph illustrating test results of a stringiness stop time; and

FIG. 5 is a graph illustrating test results of the stringiness stop time.

### DETAILED DESCRIPTION

An embodiment of a coil component including an adhesive will be described below with reference to the drawings. For easy understanding of the embodiment, elements may be shown in enlarged size in the drawings. The dimensional ratio of elements in one drawing may be different from that in another drawing or that of actual elements.

### Coil Component

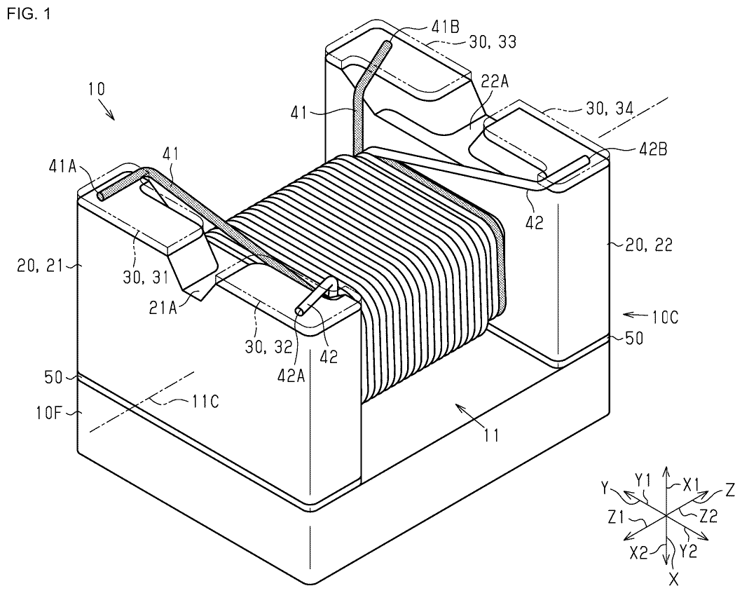

As illustrated in FIG. 1, a coil component 10 includes a drum core 10C, which serves as a first core, and a top plate 10F, which serves as a second core.

The drum core 10C includes a winding core 11. The winding core 11 has a quadrilateral prism shape having a central axis line 11C. A cross section of the winding core 11 perpendicular to the central axis line 11C has a rectangular shape. In the embodiment, “rectangular shape” includes a roughly rectangular shape having four sides, such as a rectangle having chamfered corners. Examples of the material for the winding core 11 are alumina, Ni—Zn ferrite, synthetic resin, and a mixture of these substances. In the embodiment, the material of the winding core 11 is Ni—Zn ferrite, which is one type of magnetic material.

A specific axis perpendicular to the central axis line 11C of the winding core 11 is set to a first axis X. In the embodiment, when the winding core 11 is seen in a direction along the central axis line 11C, the first axis X is parallel with the two short sides of the winding core 11. An axis perpendicular to both of the first axis X and the central axis line 11C is set to a second axis Y. In the embodiment, when the winding core 11 is seen in a direction along the central axis line 11C, the second axis Y is parallel with the two long sides of the winding core 11. An axis parallel with the central axis line 11C is set to a third axis Z. One of the directions along the first axis X is set to a first positive direction X1, while the opposite direction of the first positive direction X1 is set to a first negative direction X2. Likewise, one of the directions along the second axis Y is set to a second positive direction Y1, while the opposite direction of the second positive direction Y1 is set to a second negative direction Y2. One of the directions along the third axis Z is set to a third positive direction Z1, while the opposite direction of the third positive direction Z1 is set to a third negative direction Z2.

As illustrated in FIG. 1, the drum core 10C includes two flanges 20: one flange 20 is connected to one side of the winding core 11 and the other flange 20 is connected to the other side of the winding core 11, as is seen in the direction along the central axis line 11C. The two flanges 20 are specifically a first flange 21 and a second flange 22. The first flange 21 is connected to a first end of the winding core 11, which is the end of the third positive direction Z1. The first flange 21 has a flat, substantially quadrilateral planar shape. The thickness direction of the first flange 21 is a direction along the third axis Z. When the first flange 21 is seen in a direction along the third axis Z, the individual sides of the first flange 21 are substantially parallel with the individual sides of the winding core 11. The first flange 21 protrudes outward with respect to the outer surfaces of the winding core 11 in the direction along the first axis X and the direction along the second axis Y. That is, when the first flange 21 is seen in the direction along the third axis Z, the first flange 21 protrudes all around 360 degrees with respect to the outer surfaces of the winding core 11.

The first flange 21 has a first hollow 21A. The first hollow 21A is recessed with respect to the end surface of the first flange 21 in the first positive direction X1. The first hollow 21A is located at the center of the first flange 21 along the direction of the second axis Y. The first hollow 21A is opened at both sides of the first flange 21 in the direction along the third axis Z. With this configuration, the end surface of the first flange 21 in the first positive direction X1 is divided into two portions with the first hollow 21A therebetween.

The second flange 22 is connected to a second end of the winding core 11, which is the end of the third negative direction Z2. The shape of the second flange 22 is plane-symmetrical to that of the first flange 21. That is, the second flange 22 has a substantially quadrilateral planar shape. The second flange 22 protrudes outward with respect to the outer surfaces of the winding core 11 in the direction along the first axis X and the direction along the second axis Y. That is, when the second flange 22 is seen in the direction along the third axis Z, the second flange 22 protrudes all around 360 degrees with respect to the outer surfaces of the winding core 11. The second flange 22 has a second hollow 22A, which is similar to the first hollow 21A of the first flange 21. The material of the first and second flanges 21 and 22 is Ni—Zn ferrite, which is the same material for the winding core 11. That is, the drum core 10C is made of a magnetic material. The first and second flanges 21 and 22 are integrally formed with the winding core 11.

The top plate 10F has a flat, rectangular planar shape. The thickness direction of the top plate 10F is a direction along the first axis X. The long sides of the top plate 10F are parallel with the third axis Z. The short sides of the top plate 10F are parallel with the second axis Y. The top plate 10F is located in the first negative direction X2 with respect to the drum core 10C. The top plate 10F is connected to the surface of the first flange 21 which faces in the first negative direction X2 and is also connected to the surface of the second flange 22 which faces in the first negative direction X2. That is, the top plate 10F is connected to the drum core 10C so as to link the first and second flanges 21 and 22 therebetween like a bridge. The material of the top plate 10F is the same as the material of the winding core 11. That is, the top plate 10F is made of Ni—Zn ferrite, which is one type of magnetic material. The top plate 10F forms a closed magnetic path, together with the drum core 10C. In the embodiment, the top plate 10F around which wires, which will be discussed later, are not directly wound and elements of the drum core 10C, such as the flanges 20, around which the wires are not wound, are also regarded as a core or part of the core.

The coil component 10 includes an adhesive 50. The adhesive 50 is interposed between the drum core 10C and the top plate 10F. That is, the adhesive 50 bonds the drum core 10C and the top plate 10F with each other. In the embodiment, the drum core 10C and the top plate 10F directly contact the adhesive 50. In other words, the top plate 10F is connected to the two flanges 20 via the adhesive 50. Details of the adhesive 50 will be discussed later.

The coil component 10 includes four outer electrodes 30. More specifically, the coil component 10 includes a first electrode 31, a second electrode 32, a third electrode 33, and a fourth electrode 34. Among the outer surfaces of the first flange 21, the first electrode 31 is located on the end surface positioned toward the first positive direction X1. Among the outer surfaces of the first flange 21, the first electrode 31 is also located toward the second positive direction Y1 with respect to the central axis line 11C. More specifically, the first electrode 31 is located toward the second positive direction Y1 with respect to the first hollow 21A.

Among the outer surfaces of the first flange 21, the second electrode 32 is located on the end surface positioned toward the first positive direction X1. Among the outer surfaces of the first flange 21, the second electrode 32 is also located toward the second negative direction Y2 with respect to the central axis line 11C. More specifically, the second electrode 32 is located toward the second negative direction Y2 with respect to the first hollow 21A.

Among the outer surfaces of the second flange 22, the third electrode 33 is located on the end surface positioned toward the first positive direction X1. Among the outer surfaces of the second flange 22, the third electrode 33 is also located toward the second positive direction Y1 with respect to the central axis line 11C. More specifically, the third electrode 33 is located toward the second positive direction Y1 with respect to the second hollow 22A.

Among the outer surfaces of the second flange 22, the fourth electrode 34 is located on the end surface positioned toward the first positive direction X1. Among the outer surfaces of the second flange 22, the fourth electrode 34 is also located toward the second negative direction Y2 with respect to the central axis line 11C. More specifically, the fourth electrode 34 is located toward the second negative direction Y2 with respect to the second hollow 22A.

The outer electrode 30 has a metal layer and a plated layer, which are not shown. The material of the metal layer is silver. The metal layer is formed on the outer surface of each of the first and second flanges 21 and 22. The plated layer is constituted by three layers. The plated layer is constituted by copper, nickel, and tin layers stacked on the surface of the metal layer in this order. The end surface of the coil component 10 located toward the first positive direction X1 serves as a mounting surface at the time of the mounting of the coil component 10 on a substrate.

As shown in FIG. 1, the coil component 10 includes a first wire 41 and a second wire 42. The first and second wires 41 and 42 are wound around the winding core 11 of the drum core 10C.

The first wire 41 has a copper wire and an insulating coating, which are not shown. The insulating coating covers the outer surface of the copper wire. The first wire 41 is substantially circular in a cross section perpendicular to the extending direction of the first wire 41. The configuration of the second wire 42 is the same as that of the first wire 41. That is, the second wire 42 has a copper wire and an insulating coating. In FIG. 1, the first wire 41 is indicated by a dot pattern.

A first end 41A of the first wire 41 is connected to the first electrode 31. A second end 41B of the first wire 41 is connected to the third electrode 33. The first and second ends 41A and 41B are thermally pressure-bonded to the corresponding outer electrodes 30.

When the first wire 41 is seen in the third negative direction Z2, it is wound around the winding core 11 clockwise from the first end 41A to the second end 41B.

A first end 42A of the second wire 42 is connected to the second electrode 32. A second end 42B of the second wire 42 is connected to the fourth electrode 34. The first and second ends 42A and 42B are thermally pressure-bonded to the corresponding electrodes.

When the second wire 42 is seen in the third negative direction Z2, it is wound around the winding core 11 clockwise from the first end 42A to the second end 42B. That is, the second wire 42 is wound in the same direction as the first wire 41. The second wire 42 is wound on the outer side of the first wire 41 around the winding core 11.

### Adhesive

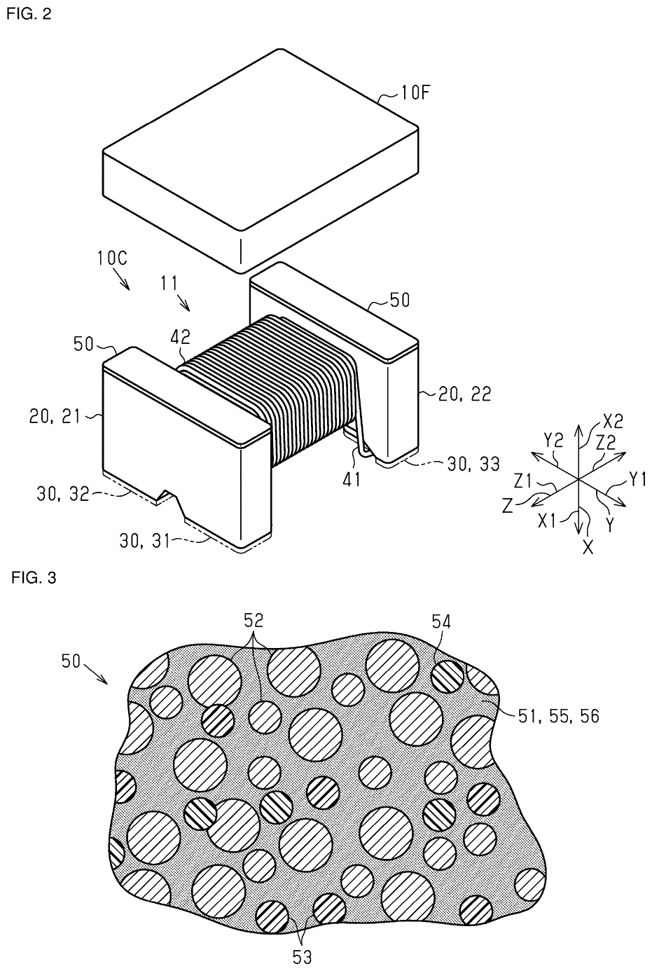

As shown in FIG. 2, the adhesive 50 covers the entire surface of the first flange 21 which faces in the first negative direction X2. The adhesive 50 connects the first flange 21 and the top plate 10F with each other without any gap therebetween. Likewise, the adhesive 50 covers the entire surface of the second flange 22 which faces in the first negative direction X2. The adhesive 50 connects the second flange 22 and the top plate 10F with each other without any gap therebetween. That is, the top plate 10F is connected to the two flanges 20.

As illustrated in FIG. 3, the adhesive 50 includes a bisphenol F resin 51, magnetic powders 52, a curing agent 53, a curing accelerator 54, a silane coupling agent 55, and a dispersant 56. The adhesive 50 shown in FIG. 3 is in a state in which it is not yet cured. In FIG. 3, only some magnetic powders 52 and only part of each of the curing agent 53 and the curing accelerator 54 are appended with reference numerals.

Specifically, the adhesive 50 is manufactured as follows. First, the bisphenol F resin 51, curing agent 53, curing accelerator 54, silane coupling agent 55, dispersant 56, and magnetic powders 52 were mixed with a kneader (model type: HIVIS MIX (registered trademark) 2P-03 (made by PRIMIX Corporation)) at 30 rpm for five minutes. Then, the resulting mixture was kneaded with a dispersing machine (model type: EXAKT 80E (made by Nagase Screen Printing Research Co., Ltd.)) at a clearance of 6 μm and at 230 rpm. As a result, the uncured adhesive 50 was manufactured.

In the embodiment, the bisphenol F resin 51 is a bisphenol F epoxy resin, and more specifically, it is CAS No. 9003-36-5. In the embodiment, the resin is collectively called the bisphenol F resin 51 regardless of whether it is a monomer or a polymer.

The number average molecular weight of the bisphenol F resin 51 is 312 g/mol. The number average molecular weight of the bisphenol F resin 51 may be any value in a range of 312 to 360 g/mol. The number average molecular weight can be measured with GPC (model type: HLC-8120GPC (made by Tosoh Techno-System Inc.)). GPC stands for Gel Permeation Chromatography. For the measurements using this machine, the temperature of columns was set to 40° C., and tetrahydrofuran was used as a solvent. The flow rate of a solution including the solvent was set to 1.0 ml/min. Monodisperse polystyrene was used as a standard sample.

In the embodiment, the volume ratio of the bisphenol F resin 51 to the adhesive 50 is 54.5 vol %, and more preferably, 54.4 to 68.7 vol %. “Volume ratio of the bisphenol F resin 51 to the adhesive 50” is the proportion of the volume of the bisphenol F resin 51 in the entire volume of the uncured adhesive 50, which is expressed in percentage.

In the embodiment, the magnetic powders 52 are nickel powders, and more specifically, it is CAS No. 7440-02-0. The magnetic powders 52 contain particles having particle sizes of 0.1 to 3.0 μm. The volume ratio of the magnetic powders 52 to the adhesive 50 is 35 vol % or lower. In the embodiment, the volume ratio of the magnetic powders 52 to the adhesive 50 is 35 vol %. The volume ratio of the magnetic powders 52 to the adhesive 50 may be 35 vol % or lower, and more preferably, 20 to 35 vol %.

In the particle size distribution of the magnetic powders 52, the median particle size (D50) is 0.8 to 2.5 μm. The median particle size (D50) of the magnetic powders 52 is calculated as follows, for example. First, samples of the magnetic powders 52 are selected with a scanning electron microscope so as to obtain the particle size distribution. Then, in the particle size distribution, in order of the smallest to the largest particle sizes, the frequency of each particle size is accumulated and the particle size whose accumulated value is 50% is set to the median particle size (D50).

The curing agent 53 is that for the bisphenol F resin 51. In the embodiment, the curing agent 53 is dicyandiamide, and more specifically, it is CAS No. 461-58-5. The volume ratio of the curing agent 53 to the adhesive 50 is 4.36 vol %, and more preferably, in a range of 4.36 to 5.49 vol %.

The curing accelerator 54 is that for the bisphenol F resin 51. In the embodiment, the curing accelerator 54 is amine adduct, and more specifically, it is CAS No. 134091-75-1. The volume ratio of the curing accelerator 54 to the adhesive 50 is 2.73 vol %, and more preferably, in a range of 2.72 to 3.43 vol %.

The dispersant 56 is used for dispersing the magnetic powders 52 in the adhesive 50. In the embodiment, the dispersant 56 is a carboxyl-group-containing polymer modified substance, and more specifically, a carboxyl-group-containing polymer modified substance having an acid value of 55 mgKOH/g. The volume ratio of the dispersant 56 to the adhesive 50 is 3.1 vol %, and more preferably, in a range of 2.18 to 3.13 vol %.

In the embodiment, the silane coupling agent 55 is glycidoxypropyltrimethoxysilane, and more specifically, it is CAS No. 253-83-8. The volume ratio of the silane coupling agent 55 to the adhesive 50 is 0.3 vol %, and more preferably, in a range of 0.24 to 0.35 vol %.

### Properties of Adhesive

The glass transition temperature of the adhesive 50 in the cured state is 125° C. or higher. The glass transition temperature of the adhesive 50 was measured as follows. First, the bisphenol F resin 51, curing agent 53, curing accelerator 54, silane coupling agent 55, dispersant 56, and magnetic powders 52 were mixed and were then burned at a temperature of 150° C. for three hours. As a result, an adhesion test specimen in the cured state was created. The dimensions of the adhesion test specimen were a length of 20 mm, a width of 10 mm, and a thickness of 1.5 mm. The short sides of the adhesion test specimen were fixed to a viscoelasticity measuring device (model type: DMS7100 (made by Hitachi High-Tech Corporation)) and the modulus of elasticity was measured. In the measurements, the temperature was raised while a sine wave of a frequency of 1 Hz was being applied to the adhesion test specimen. The temperature was raised at a rate of 5° C./min. The temperature range was 25° C. to 280° C. Then, the transition of the modulus of elasticity of the adhesion test specimen with respect to the temperature rise was measured, and the point of inflection was set to the glass transition temperature.

The adhesion strength of the cured adhesive 50 is 10 MPa or higher. The adhesion strength of the adhesive 50 was measured as follows. First, the bisphenol F resin 51, curing agent 53, curing accelerator 54, dispersant 56, silane coupling agent 55, and magnetic powders 52 were mixed, resulting in the adhesive 50 in the uncured state. Then, the uncured adhesive 50 was applied to a space of 5×5 square millimeters between two alumina substrates. That is, the adhesion strength of the adhesive 50 per 25 square millimeters was measured. Then, the two alumina substrates coated with the uncured adhesive 50 were burned at a temperature of 150° C. for three hours. As a result, an adhesion test specimen in the cured state was created. Then, one alumina substrate and the other alumina substrate were fixed to an autograph (model type: AG XD Plus (made by Shimadzu Corporation)) and tensile testing was conducted. That is, in the embodiment, the tensile adhesion strength was measured as the adhesion strength. In the testing, the tensile speed was 20 mm/min. A load when the adhesion test specimen was broken was determined to be the adhesion strength of the adhesive 50. In the testing, the temperature was 23° C. and the relative humidity was 50%.

### Continuous Printability of Adhesive

Four samples of the adhesive 50 were formed by varying the number average molecular weight of the bisphenol F resin 51, and the stringiness stop time of each sample was measured. Except for the number average molecular weight of the bisphenol F resin 51, the other conditions were the same for the four samples. The volume ratios of the magnetic powders 52 in the four samples were all 35 vol %. The volume ratio of the magnetic powders 52 is that in the uncured adhesive 50. The stringiness stop time is a period of time from when the uncured adhesive 50 is applied to a substrate with a squeegee by using a screen printer and the squeegee is removed from the substrate until when the adhesive 50 being in a stringy state between the squeegee and the substrate is separated from the squeegee. In the measurements of the stringiness stop time, the conditions of the screen printer were set as follows: the printing speed was 60 mm/s; the air pressure was 0.2 MPa; the back pressure was 0.125 MPa; and the clearance was 1 mm. Under these conditions, printing was continuously performed 100 times, and the stringiness stop times in the first printing, twenty-fifth printing, fiftieth printing, and hundredth printing were measured, and the average of the stringiness stop times was set to the representative value.

The number average molecular weights of the bisphenol F resin 51 in the four samples were set as follows: the first sample was 312 g/mol, which is the same as that in the embodiment; the second sample was 340 g/mol; the third sample was 360 g/mol; and the fourth sample was 380 g/mol. These four samples correspond to first, second, and third examples and a first comparative example in Table 1, which is shown below.

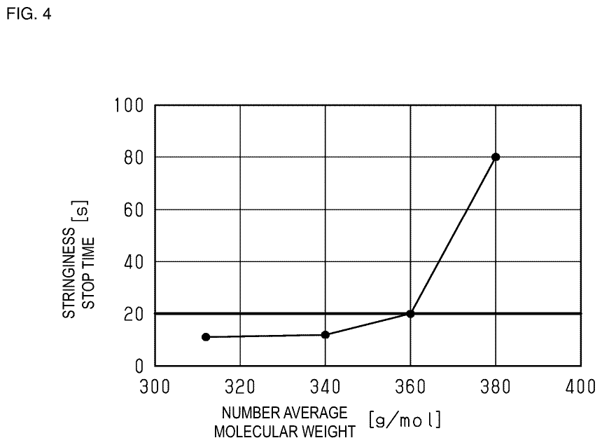

As is seen from FIG. 4, the stringiness stop times of the four samples are as follows: the first sample is 11 seconds; the second sample is 12 seconds; the third sample is 20 seconds; and the fourth sample is 80 seconds. It is seen from FIG. 4 that, as the number average molecular weight of the bisphenol F resin 51 in the adhesive 50 is larger, the stringiness stop time becomes longer and that, when the number average molecular weight of the bisphenol F resin 51 exceeds 360 g/mol, the stringiness stop time suddenly soars. That is, the point of inflection of the stringiness stop time with respect to an increase in the number average molecular weight is about 360 g/mol. In a case in which the adhesive 50 is applied with a screen printer, as the stringiness stop time is longer, the time to wait in a state in which the squeegee is being separated from the substrate becomes longer, thereby making the continuous printability poor. It can thus be said that the number average molecular weight of the bisphenol F resin 51 in the adhesive 50 is preferably 360 g/mol or smaller in terms of easy handling of the adhesive 50.

Five samples of the adhesive 50 were formed by varying the volume ratio of the magnetic powders 52, and the stringiness stop time of each sample was measured. Except for the volume ratio of the magnetic powders 52, the other conditions were the same for the five samples. The number average molecular weights of the bisphenol F resin 51 in the five samples were all 340 g/mol. The definition of the stringiness stop time is as described above. The volume ratios of the magnetic powders 52 in the five samples were set as follows: the first sample was 20 vol %; the second sample was 25 vol %; the third sample was 30 vol %; the fourth sample was 35 vol %; and the fifth sample was 40 vol %. The volume ratio of the magnetic powders 52 is that in the uncured adhesive 50. These five samples correspond to fourth, fifth, sixth, and second examples and a second comparative example in Table 1, which is shown below.

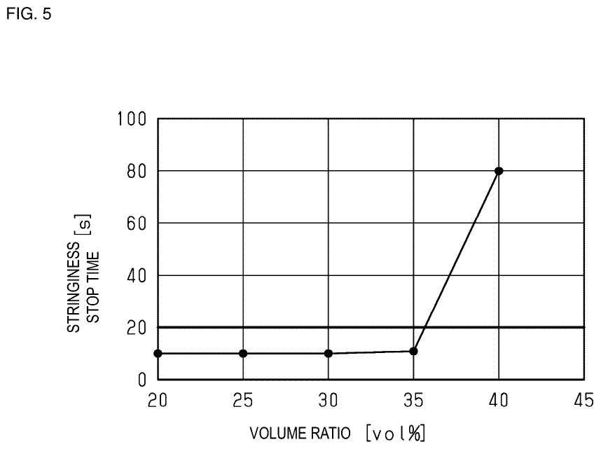

As is seen from FIG. 5, the stringiness stop times of the five samples are as follows: the first sample is 10 seconds, the second sample is 10 seconds, the third sample is 11 seconds, the fourth sample is 12 seconds, and the fifth sample is 80 seconds. It is seen from FIG. 5 that, when the volume ratio of the magnetic powders 52 to the adhesive 50 exceeds 35 vol %, the stringiness stop time suddenly soars. That is, the point of inflection of the stringiness stop time with respect to an increase in the volume ratio of the magnetic powders 52 is about 35 vol %. It can thus be said that the volume ratio of the magnetic powders 52 to the adhesive 50 is preferably 35 vol % or lower in terms of easy handling of the adhesive 50.

### Comparative Test

Adhesives of first through ninth examples and those of comparative first and second examples shown in the following Table 1 and Table 2 were formed. Then, the properties of the uncured adhesives and those of the cured adhesives of these examples and comparative examples were examined. In the adhesives of the first through ninth examples and the comparative first and second examples, the synthetic resin is a bisphenol F epoxy resin. In the adhesives of the first through sixth examples and the comparative first and second examples, the median particle size (D50) of the magnetic powders 52 is 0.8 μm. The adhesives of the first through ninth examples and the comparative first and second examples each contain the magnetic powders 52, curing agent 53, curing accelerator 54, silane coupling agent 55, and dispersant 56.

### First Through Sixth Examples

The results of the comparative test for the first through sixth examples and the first and second comparative examples will be explained below.

TABLE 1

| | Material | | | | | | | | |
|---|---|---|---|---|---|---|---|---|---|
| | | Number | Magnetic | | | | Properties (cured) | | |
| | | average | powder | Properties (uncured) | | | | Glass | |
| | | molecular | volume | | Stringiness | Test | | transition | Adhesion |
| | | weight | ratio | Viscosity | stop time | results | | temperature | strength |
| | Resin | [g/mol] | [vol %] | [Pa · s] | [s] | [≤20] | Permeability | [° C.] | [MPa] |
| First | Bisphenol F | 312 | 35 | 1833 | 11 | OK | 2.5 | 125 | 14 |
| example | epoxy resin | | | | | | | | |
| Second | Bisphenol F | 340 | 35 | 2528 | 12 | OK | 2.5 | 125 | 14 |
| example | epoxy resin | | | | | | | | |
| Third | Bisphenol F | 360 | 35 | 3223 | 20 | OK | 2.5 | 125 | 14 |
| example | epoxy resin | | | | | | | | |
| Fourth | Bisphenol F | 340 | 20 | 283 | 10 | OK | 1.7 | 125 | 14 |
| example | epoxy resin | | | | | | | | |
| Fifth | Bisphenol F | 340 | 25 | 567 | 10 | OK | 2.0 | 125 | 14 |
| example | epoxy resin | | | | | | | | |
| Sixth | Bisphenol F | 340 | 30 | 1143 | 11 | OK | 2.2 | 125 | 14 |
| example | epoxy resin | | | | | | | | |
| First | Bisphenol F | 380 | 35 | 3760 | 80 | NG | 2.5 | 125 | 14 |
| comparative | epoxy resin | | | | | | | | |
| example | | | | | | | | | |
| Second | Bisphenol F | 340 | 40 | 4507 | 80 | NG | 2.9 | 125 | 14 |
| comparative | epoxy resin | | | | | | | | |
| example | | | | | | | | | |

As shown in Table 1, the properties of the adhesive of the first example are as follows: the number average molecular weight of the bisphenol F resin 51 is 312 g/mol; the volume ratio of the magnetic powders 52 is 35 vol %; the viscosity of the adhesive in the uncured state is 1833 Pa·s; the permeability of the adhesive in the cured state is 2.5; the glass transition temperature of the adhesive in the cured state is 125° C.; and the adhesion strength of the adhesive in the cured state is 14 MPa.

The viscosity was measured with a rotational rheometer (model type: MCR302 (made by Anton Paar GmbH)). In the measurements using this machine, a cone-plate having a diameter φ of 25 mm was used, the rotation mode was set to flow curve, the shear rate was set to 0.01 s⁻¹, and the temperature in the testing was 25° C.

The permeability was measured in the following manner. First, the bisphenol F resin 51, curing agent 53, curing accelerator 54, dispersant 56, silane coupling agent 55, and magnetic powders 52 were mixed, resulting in the uncured adhesive 50. Then, the uncured adhesive 50 was burned at a temperature of 85° C. for one hour, resulting in the semi-cured adhesive 50. Then, the semi-cured adhesive 50 was filled into a mold having an outer diameter q of 16 mm and an inner diameter φ of 10 mm and was heated and pressed with a small hot pressing machine (model type: H300-15 (made by AS ONE Corporation)) for 15 minutes at a pressure of 4 MPa and at a heating temperature of 150° C. As a result, a toroidal core was formed. The complex permeability of the toroidal core was measured with an impedance analyzer (model type: E4991A (made by Keysight Technologies)) under a condition of 10 MHz. The real part of the complex permeability was determined to be the permeability. The temperature in the testing was 25° C.

The properties of the adhesive of the second example are as follows: the number average molecular weight of the bisphenol F resin 51 is 340 g/mol; the volume ratio of the magnetic powders 52 is 35 vol %; the viscosity of the adhesive in the uncured state is 2528 Pa·s; the permeability of the adhesive in the cured state is 2.5; the glass transition temperature of the adhesive in the cured state is 125° C.; and the adhesion strength of the adhesive in the cured state is 14 MPa.

The properties of the adhesive of the third example are as follows: the number average molecular weight of the bisphenol F resin 51 is 360 g/mol; the volume ratio of the magnetic powders 52 is 35 vol %; the viscosity of the adhesive in the uncured state is 3223 Pa·s; the permeability of the adhesive in the cured state is 2.5; the glass transition temperature of the adhesive in the cured state is 125° C.; and the adhesion strength of the adhesive in the cured state is 14 MPa.

The properties of the adhesive of the fourth example are as follows: the number average molecular weight of the bisphenol F resin 51 is 340 g/mol; the volume ratio of the magnetic powders 52 is 20 vol %; the viscosity of the adhesive in the uncured state is 283 Pa·s; the permeability of the adhesive in the cured state is 1.7; the glass transition temperature of the adhesive in the cured state is 125° C.; and the adhesion strength of the adhesive in the cured state is 14 MPa.

The properties of the adhesive of the fifth example are as follows: the number average molecular weight of the bisphenol F resin 51 is 340 g/mol; the volume ratio of the magnetic powders 52 is 25 vol %; the viscosity of the adhesive in the uncured state is 567 Pa·s; the permeability of the adhesive in the cured state is 2.0; the glass transition temperature of the adhesive in the cured state is 125° C.; and the adhesion strength of the adhesive in the cured state is 14 MPa.

The properties of the adhesive of the sixth example are as follows: the number average molecular weight of the bisphenol F resin 51 is 340 g/mol; the volume ratio of the magnetic powders 52 is 30 vol %; the viscosity of the adhesive in the uncured state is 1143 Pa·s; the permeability of the adhesive in the cured state is 2.2; the glass transition temperature of the adhesive in the cured state is 125° C.; and the adhesion strength of the adhesive in the cured state is 14 MPa.

The properties of the adhesive of the first comparative example are as follows: the number average molecular weight of the bisphenol F resin 51 is 380 g/mol; the volume ratio of the magnetic powders 52 is 35 vol %; the viscosity of the adhesive in the uncured state is 3760 Pa·s; the permeability of the adhesive in the cured state is 2.5; the glass transition temperature of the adhesive in the cured state is 125° C.; and the adhesion strength of the adhesive in the cured state is 14 MPa.

The properties of the adhesive of the second comparative example are as follows: the number average molecular weight of the bisphenol F resin 51 is 340 g/mol; the volume ratio of the magnetic powders 52 is 40 vol %; the viscosity of the adhesive in the uncured state is 4507 Pa·s; the permeability of the adhesive in the cured state is 2.9; the glass transition temperature of the adhesive in the cured state is 125° C.; and the adhesion strength of the adhesive in the cured state is 14 MPa.

The results of the stringiness stop time in the comparative test are as follows: the first example is 11 seconds; the second example is 12 seconds; the third example is 20 seconds; the fourth example is 10 seconds; the fifth example is 10 seconds; the sixth example is 11 seconds; the first comparative example is 80 seconds; and the second comparative example is 80 seconds.

In the field of “Test results” of “Properties (uncured)” in Table 1 and Table 2, “OK” means that the stringiness stop time is 20 seconds or shorter, while “NG” means that the stringiness stop time is longer than 20 seconds. The value used in the test results is determined based on whether the adhesive 50 which is stringy and does not separate from the squeegee may adhere to any substance other than a printing medium.

The test results of the first through sixth examples and the first comparative example show that, when the number average molecular weight of the bisphenol F resin 51 is large, the stringiness stop time tends to become long. That is, as in the measurement results of the stringiness stop time using the above-described four samples, when the number average molecular weight of the bisphenol F resin 51 exceeds 360 g/mol, a rate of increase in the stringiness stop time suddenly becomes high. In other words, it can be said that the number average molecular weight of the bisphenol F resin 51 in the adhesive 50 is preferably 360 g/mol or smaller.

The test results of the first through sixth examples and the second comparative example show that, when the volume ratio of the magnetic powders 52 is high, the stringiness stop time tends to become long. That is, as in the measurement results of the stringiness stop time using the above-described five samples, when the volume ratio of the magnetic powders 52 exceeds 35 vol %, a rate of increase in the stringiness stop time suddenly becomes high. In other words, it can be said that the volume ratio of the magnetic powders 52 is preferably 35 vol % or lower.

In the case of the adhesive of the third example whose viscosity is 3223 Pa·s, the stringiness stop time is 20 seconds. In the case of the adhesive of the first comparative example whose viscosity is 3760 Pa·s, the stringiness stop time is 80 seconds. It is thus seen that the point of inflection regarding the transition of the stringiness stop time with respect to an increase in the viscosity can be estimated to 3223 to 3760 Pa·s, that is, about 3500 Pa·s. It can thus be said that the viscosity of the adhesive is preferably 3500 Pa·s or lower, for example.

The permeability of the adhesives in the cured state in all the first through sixth examples exceeds 1.7. If the permeability of an adhesive exceeds 1.7, this adhesive can be put to practical use as the adhesive 50 for bonding the drum core 10C and the top plate 10F of the coil component 10. That is, the permeability of each of the adhesives of the first through sixth examples is sufficient for the adhesive 50 of the coil component 10.

### Second, Third, and Seventh Through Ninth Examples

The results of the comparative test for the second, third, and seventh through ninth examples will be explained below.

TABLE 2

| | Material | | | | | | |
|---|---|---|---|---|---|---|---|
| | | Number | Magnetic | | | | |
| | | average | powder | Median | Properties (uncured) | | |
| | | molecular | volume | particle | | Stringiness | Test |
| | | weight | ratio | size (D50) | Viscosity | stop time | results |
| | Resin | [g/mol] | [vol %] | [μm] | [Pa · s] | [s] | [≤20] |
| Second | Bisphenol F | 340 | 35 | 0.8 | 2528 | 11 | OK |
| example | epoxy resin | | | | | | |
| Third | Bisphenol F | 360 | 35 | 0.8 | 3223 | 20 | OK |
| example | epoxy resin | | | | | | |
| Seventh | Bisphenol F | 340 | 35 | 0.5 | 2911 | 16 | OK |
| example | epoxy resin | | | | | | |
| Eighth | Bisphenol F | 360 | 35 | 1.5 | 1820 | 11 | OK |
| example | epoxy resin | | | | | | |
| Ninth | epoxy resin | 340 | 25 | 2.5 | 1137 | 11 | OK |
| example | Bisphenol F | | | | | | |

As shown in Table 2, the adhesive of the second example is the adhesive of the above-described second example. That is, the median particle size (D50) of the magnetic powders 52 in this adhesive is 0.8 μm. The adhesive of the third example is the adhesive of the above-described third example. That is, the median particle size (D50) of the magnetic powders 52 in this adhesive is 0.8 μm.

The properties of the adhesive of the seventh example are as follows: the number average molecular weight of the bisphenol F resin 51 is 340 g/mol; the volume ratio of the magnetic powders 52 is 35 vol %; the median particle size (D50) of the magnetic powders 52 is 0.5 μm; and the viscosity of the adhesive in the uncured state is 2911 Pa·s.

The properties of the adhesive of the eighth example are as follows: the number average molecular weight of the bisphenol F resin 51 is 360 g/mol; the volume ratio of the magnetic powders 52 is 35 vol %; the median particle size (D50) of the magnetic powders 52 is 1.5 μm; and the viscosity of the adhesive in the uncured state is 1820 Pa·s.

The properties of the adhesive of the ninth example are as follows: the number average molecular weight of the bisphenol F resin 51 is 340 g/mol; the volume ratio of the magnetic powders 52 is 25 vol %; the median particle size (D50) of the magnetic powders 52 is 2.5 μm; and the viscosity of the adhesive in the uncured state is 1137 Pa·s.

The results of the stringiness stop time in the comparative test are as follows: the seventh example is 16 seconds; the eighth example is 11 seconds; and the ninth example is 11 seconds.

The test results of the second, third, and seventh through ninth examples show that, when the median particle size (D50) of the magnetic powders 52 is in a range of 0.8 to 2.5 μm, the stringiness stop time is 20 seconds or shorter and that, as the median particle size (D50) of the magnetic powders 52 in the adhesive 50 is smaller, the viscosity tends to become higher. It can thus be said that the median particle size (D50) of the magnetic powders 52 is preferably 0.8 μm or larger.

### Advantages of Embodiment

(1) In the embodiment, the adhesive 50 includes the magnetic powders 52 and thus has a higher permeability than that without the magnetic powders 52. As the number average molecular weight of the bisphenol F resin 51 in the adhesive 50 is larger, the viscosity of the adhesive 50 tends to become higher. Examples of the number average molecular weight of a typical commercially available bisphenol F epoxy resin are about 3300 g/mol and about 5500 g/mol. In contrast, the number average molecular weight of the bisphenol F resin 51 in the embodiment is 312 to 360 g/mol, which is much smaller than that of a typical bisphenol F resin. Using the bisphenol F resin 51 having a number average molecular weight in this range can regulate an increase in the viscosity of the adhesive 50.

Likewise, as the volume ratio of the magnetic powders 52 to the adhesive 50 is higher, the viscosity of the adhesive 50 tends to become higher. In the embodiment, the volume ratio of the magnetic powders 52 to the adhesive 50 is 35 vol % or lower. Using the magnetic powders 52 having such a volume ratio can regulate an increase in the viscosity of the adhesive 50.

With the above-described configurations, the adhesive 50 can secure a sufficiently high permeability to be used as an adhesive for the coil component 10 and is also simple and easy to handle at the time of the manufacturing of the coil component 10. Among others, using the adhesive 50 of the embodiment can lower the stringiness stop time when the uncured adhesive 50 is being applied to the top plate 10F of the coil component 10 with a screen printer. That is, the adhesive 50 is desirable also in terms of the continuous printability.

(2) In the embodiment, the volume ratio of the magnetic powders 52 to the adhesive 50 is 20 vol % or higher. With this volume ratio, the adhesive 50 to be applied to the coil component 10 achieves a desirable permeability.

(3) In the embodiment, the adhesive 50 includes the silane coupling agent 55. Using the silane coupling agent 55 can enhance the adhesion strength of the adhesive 50. In particular, in the embodiment, the adhesive 50 is interposed between the drum core 10C and the top plate 10F, and the silane coupling agent 55 is useful for bonding such inorganic materials.

(4) In the embodiment, the adhesive 50 includes the dispersant 56. Using the dispersant 56 can make it difficult for the magnetic powders 52 to aggregate. For this reason, even if the volume ratio of the magnetic powders 52 is high to a certain level, for example, the magnetic powders 52 are less likely to aggregate.

(5) In the embodiment, the glass transition temperature of the adhesive 50 is 125° C. or higher. This can improve the heat resistance of the adhesive 50. For this reason, even if the coil component 10 is used in the environment of high temperatures, for example, the reliability of the coil component 10 is less likely to deteriorate.

(6) In the embodiment, the median particle size (D50) of the magnetic powders 52 is 0.8 μm or larger. As the median particle size (D50) of the magnetic powders 52 in the adhesive 50 is smaller, the viscosity tends to become higher. The results of the above-described comparative test show that using the magnetic powders 52 having a median particle size (D50) of 0.8 μm or larger can regulate an increase in the stringiness stop time.

(7) In the embodiment, the median particle size (D50) of the magnetic powders 52 is 2.5 μm or smaller. As the median particle size (D50) of the magnetic powders 52 is larger, the magnetic powders 52 tend to collide with each other in the adhesive 50. That is, depending on the shape of a portion to be coated with the adhesive 50, the magnetic powders 52 do not match the shape of this portion and may become nonuniform in the adhesive 50. Using the magnetic powders 52 having a median particle size (D50) in the above-described range is less likely to cause these problems.

(8) In the embodiment, the adhesion strength of the adhesive 50 per 25 square millimeters with respect to alumina is 10 MPa or higher. Using the adhesive 50 having such an adhesion strength also achieves a sufficient adhesion strength of the coil component 10.

(9) In the embodiment, the coil component 10 has a closed magnetic path formed by the flanges 20 and the top plate 10F. Using the adhesive 50 of the embodiment to bond the flanges 20 and the top plate 10F, which form a closed magnetic path, with each other is desirable for enhancing the characteristics of the coil component 10 as a whole.

### Modified Examples

The above-described embodiment and the following modified examples may be combined with each other in a suitable manner and be carried out as long as the resulting configurations do not become technically inconsistent.

### Modified Examples of Coil Component

The shape of the winding core 11 is not limited to the example in the embodiment. For instance, the shape of the winding core 11 may be a cylinder or a polygonal prism other than a quadrilateral prism.

The configuration of the drum core 10C is not limited to the example in the embodiment. For instance, the provision of the first hollow 21A and the second hollow 22A for the drum core 10C may be omitted if the first electrode 31 and the second electrode 32 are separated from each other and the third electrode 33 and the fourth electrode 34 are separated from each other, for example.

The material and the shape of the outer electrodes 30 are not limited to the examples in the embodiment. In one example, the material of the plated layer of the outer electrodes 30 may be an alloy of tin and nickel, for example. In another example, the provision of the plated layer for the outer electrodes 30 may be omitted. In this case, a portion where a metal layer having conductivity is exposed may be used as the outer electrode 30.

The coil component 10 may include at least one wire. If the coil component 10 includes one wire, any number of outer electrodes 30 may be provided if one outer electrode 30 is disposed on the first flange 21 and one outer electrode 30 is disposed on the second flange 22.

The configuration of the coil component 10 is not limited to that constituted by the drum core 10C and the top plate 10F. The coil component 10 may be configured in any manner as long as it includes a first core around which a wire is wound and a second core connected to the first core via the adhesive 50 and the first core and the second core are bonded with each other by the adhesive 50.

### Modified Examples of Adhesive

The adhesive 50 may be applied to a component other than the coil component 10. Preferably, the adhesive 50 is applied to an electronic component including a core made of a magnetic material.

The type of curing agent 53 contained in the adhesive 50 is not limited to the example in the embodiment. Any type of curing agent compatible with the bisphenol F resin 51 may be used.

The volume ratio of the magnetic powders 52 to the adhesive 50 may be any value of 35 vol % or lower. That is, the volume ratio of the magnetic powders 52 to the adhesive 50 may be lower than 20 vol %. The volume ratio of the magnetic powders 52 is set so that a desirable permeability can be obtained in a coil component 10 to which the adhesive 50 is applied.

The number average molecular weight of the bisphenol F resin 51 in the adhesive 50 may be any value in a range of 312 to 360 g/mol.

The silane coupling agent 55, dispersant 56, and curing accelerator 54 may be omitted from the adhesive 50. The types of silane coupling agent 55, dispersant 56, and curing accelerator 54 are not limited to the examples in the embodiment.

The glass transition temperature of the cured adhesive 50 may be lower than 125° C. A desirable glass transition temperature may be determined in accordance with the purpose of use of the adhesive 50.

The median particle size (D50) of the magnetic powders 52 in the adhesive 50 may be smaller than 0.8 μm or larger than 2.5 μm. A desirable value of the median particle size (D50) may be determined so that the adhesive 50 can be handled in a suitable manner.

The adhesion strength of the cured adhesive 50 per 25 square millimeters with respect to alumina may be lower than 10 MPa. Preferably, the adhesion strength of the adhesive 50 is in a range of values which allows the top plate 10F and the drum core 10C to be sufficiently bonded with each other.

### APPENDIX

The technical concept that can be derived from the above-described embodiment and modified examples is as follows.

[1] An adhesive comprising a bisphenol F resin; a curing agent for the bisphenol F resin; and magnetic powder. A volume ratio of the magnetic powder to the adhesive is 35 vol % or lower, and a number average molecular weight of the bisphenol F resin is 312 to 360 g/mol.

[2] The adhesive according to [1], wherein the volume ratio of the magnetic powder to the adhesive is 20 vol % or higher.

[3] The adhesive according to [1] or [2], further comprising a silane coupling agent.

[4] The adhesive according to one of [1] to [3], further comprising a dispersant for dispersing the magnetic powder.

[5] The adhesive according to one of [1] to [4], wherein a median particle size (D50) of the magnetic powder is 0.8 μm or larger.

[6] The adhesive according to one of [1] to [5], wherein a median particle size (D50) of the magnetic powder is 2.5 μm or smaller.

[7] The adhesive according to one of [1] to [6], wherein a glass transition temperature of the adhesive in a cured state is 125° C. or higher.

[8] The adhesive according to one of [1] to [7], wherein an adhesion strength of the adhesive in a cured state per 25 square millimeters with respect to alumina is 10 MPa or higher.

What is claimed is:

1. An adhesive comprising:
a bisphenol F resin;
a curing agent for the bisphenol F resin; and
magnetic powder,
wherein
a volume ratio of the magnetic powder to the adhesive is 35 vol % or lower, and
a number average molecular weight of the bisphenol F resin is 312 to 360 g/mol.

2. The adhesive according to claim 1, wherein
the volume ratio of the magnetic powder to the adhesive is 20 vol % or higher.

3. The adhesive according to claim 1, further comprising:
a silane coupling agent.

4. The adhesive according to claim 1, further comprising:
a dispersant for dispersing the magnetic powder.

5. The adhesive according to claim 1, wherein
a median particle size (D50) of the magnetic powder is 0.8 μm or larger.

6. The adhesive according to claim 1, wherein
a median particle size (D50) of the magnetic powder is 2.5 μm or smaller.

7. The adhesive according to claim 1, wherein
a glass transition temperature of the adhesive in a cured state is 125° C. or higher.

8. The adhesive according to claim 1, wherein
an adhesion strength of the adhesive in a cured state per 25 square millimeters with respect to alumina is 10 MPa or higher.
